(19) United States
(12) Patent Application Publication
(10) Pub. No.: US 2006/0153372 A1
(43) Pub. Date: Jul. 13, 2006

(54) Smart card and method protecting secret key

(76) Inventors: Chong-Hee Kim, Suwon-si (KR); Ki-Hun Lee, Suwon-si (KR)

Correspondence Address: HARNESS, DICKEY & PIERCE, P.L.C., P.O. BOX 8910, RESTON, VA, 20195, US

(21) Appl. No.: 11/328,120

(22) Filed: Jan. 10, 2006

(30) Foreign Application Priority Data
Jan. 10, 2005 (KR) 2005-002281

(51) Int. Cl. H04L 9/30

(52) U.S. Cl. 380/30

(57) ABSTRACT

A smart card and method protecting a secret key, wherein the method may include receiving a ciphertext and a secret key, generating a table, receiving at least one random number chain, executing a logic operation for the secret key and the random number chain, and decoding the ciphertext. The smart card may include a pseudo random number generator and a processor.

### PRIORITY CLAIM

A claim of priority is made under 35 U.S.C. § 119 to Korean Patent Application 2005-02281 filed on Jan. 10, 2005, the entire contents of which are hereby incorporated by reference.

### BACKGROUND

Example embodiments of the present invention relate to smart cards, and more particularly to smart cards capable of preventing a secret key from being vulnerable to external attacks.

Digital systems may be protected by encryption algorithms using a secret key. However, a secret key may be vulnerable to external attacks because an encryption algorithm may not have been designed to prevent a leak of unforeseen information. The leak of unforeseen information may be a serious problem to the security of a system using the smart cards. Leakage of such unforeseen information may be via side channel information, and attacks taking advantage of the side channel information may be referred to as side channel attacks. Side channel attacks may be classified as timing, fault insertion, or power analysis. A timing attack may be used as a method of obtaining a secret key by analyzing a time difference in processing information between a secret key and another data. A fault insertion attack may be used as a method of obtaining a secret key by analyzing data after intentionally placing fault data into the smart card. A power analysis attack may be used to obtain a secret key by comparatively analyzing amount of used and unused in processing data relevant to a secret key. A power analysis attack may be classified into a simple power analysis (SPA) attack and a differential power analysis (DPA) attack.

Recently, there has been a lot of interest and study into a side channel attack against a smart card having a cipher-exclusive operating unit. A smart card that may cipher-exclusive ORs a plain-text data with a single, random, fixed-length secret key. There may be a high probability of information leakage through a side channel attack, because many smart cards have a relatively small memory and a processor having low arithmetic capability. A processor may be required for repeat arithmetic processing of secret data such as an authentication process. An effective method of attacking a system may be a power analysis attack, which measures an amount of power consumed to find a secret key. This power analysis attack may monitor a transient variation of power at the time of activating an encryption algorithm and a secret key built into a smart card, and then, decrypt the secret key by means of a statistics method using techniques of estimation and error correction. A DPA attack may be more effective than a method of employing an exclusive decryption apparatus or a super computer, because it may be easier to estimate a secret key just by using several devices capable of monitoring voltage variation.

A processor of a smart card using secret key cryptographic system may utilize a non-manipulated secret key. A non-manipulated secret key may mean the original secret key before encryption. Therefore, the secret key may be easily recovered by a DPA attack. For instance, if a ciphertext and a secret key are input to a processor of a smart card, the processor may divide the secret key into unit blocks of operation word size. The blocked secret key may be applied in decoding (or decrypting) the ciphertext from reading each bit of the secret key by means of shift bit operators. In other words, a unit operation of each bit of the secret key may be processed in the processor of the smart card. Accordingly, a secret key decoding operation in a processor of a smart card, may have a problem, such as vulnerability to a DPA attack.

### SUMMARY OF THE INVENTION

Example embodiments of the present invention may be directed to a cryptographic method and a smart card using the same.

In an example embodiment of the present invention, a cryptographic method may include receiving a ciphertext and a secret key, generating a table to be used for decryption based on the ciphertext and the secret key, receiving at least one random number chain, executing a logic operation with the secret key and the least one random number chain, and decrypting the ciphertext using a resultant value of the logic operation, the random number chain, and the table.

In another example embodiment of the present invention, a cryptographic method may include receiving a ciphertext and a secret key, generating a table to be used for decryption based on the ciphertext and the secret key, dividing the secret key into a plurality of blocks, receiving at least one random number chain, executing an XOR operation with one of the plurality of blocks and the least one random number chain, and decrypting the ciphertext.

Also in another example embodiment of the present invention, a smart card may include a pseudo random number generator adapted to generate a random number chain with a definite length, and a processor adapted to receive a ciphertext and a secret key to generate a table, and the processor further adapted to receive the random number chain, execute a logic operation on the random number chain and secret key, and execute a cipher decryption operation by using a resultant value obtained from the logic operation, the table, and the random number chain.

### BRIEF DESCRIPTION OF THE DRAWINGS

The accompanying drawings are included to provide further understanding of example embodiments of the present invention, and are incorporated in and constitute a part of this specification. The drawings together with the description illustrate the example embodiments of the present invention. In the drawings:

FIG. 1 is a block diagram illustrating a smart card in accordance with an example embodiment of the present invention;

FIG. 2 is a flow chart illustrating a procedure in accordance with an example embodiment of the present invention; and

FIG. 3 is a flow chart illustrating an arithmetic procedure in accordance with an example embodiment of the present invention.

### DETAILED DESCRIPTION OF EXAMPLE EMBODIMENTS

Example embodiments of the present invention will be described below in more detail with reference to the accompanying drawings. The present invention may, however, be embodied in different forms and should not be constructed as limited to the example embodiments set forth herein. Rather, these example embodiments are provided as working example. Like numerals may refer to like elements throughout the specification.

The terminology used herein is for the purpose of describing particular example embodiments only and is not intended to be limiting of the present invention. As used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

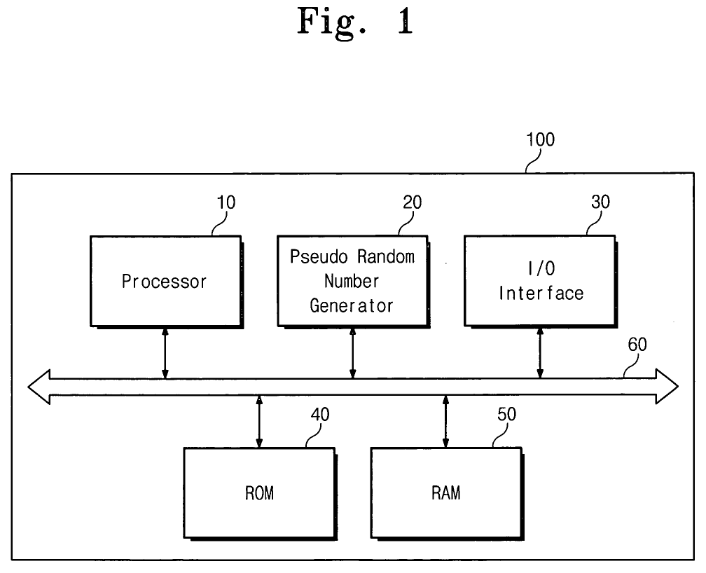

FIG. 1 is a block diagram illustrating a smart card in accordance with an example embodiment of the present invention.

Referring to FIG. 1, a smart card 100 may includes a processor 10, a pseudo random number generator 20, an input/output (I/O) interface unit 30, a read only memory (ROM) 40, a random access memory (RAM) 50, and/or a data bus 60.

The processor 10 may be a central processing unit (CPU), microprocessor, and the like. The processor 10 may control internal signals and data paths to access components such as data memory, program memory, the RAM, and so forth. The processor 10 may conduct various operations using a ciphertext and a secret key.

The pseudo random number generator 20 may include a linear feedback shift register and an asymmetrical cryptography block, capable of storing random number chains. The pseudo random number generator 20 may generate random number chains repeated with a definite length. The random number chains may be supplied to the processor 10 to prevent a secret key from being disclosed during an operation. An “operation” may mean an arithmetic operation, e.g., an encryption operation or a decryption operation, unless otherwise specifically stated.

The I/O interface unit 30 may be provided for transferring data, addresses, and commands between the smart card 100 and external apparatuses.

The ROM 40 may be used as a program memory and may contain an operating system and basic instructions for the smart card 100. The RAM 50 may be used as a working register and may store temporary data and intermediately calculated results. The data bus 60 may be used as a transferring channel for various data in the smart card 100.

The processor 10 may function to process arithmetic encryption and decryption (or decoding) operations.

A cryptography algorithm may be a procedure of transforming a plaintext (original information) to a ciphertext (encrypted information) by means of an encryption key. The procedure of transforming the ciphertext to the original plaintext by a decryption key may be known as decryption (decoding or deciphering). The cryptographic scheme may be composed of a symmetric cryptosystem in which an encryption key may be identical to a decryption key, and an asymmetric cryptosystem in which the encryption key may be different from the decryption key. To transfer data with the symmetric cryptosystem, a key shared by a data transmitter and a receiver may be required. The key may be a secret key that must not be externally disclosed, because it may be commonly used for encryption and decryption. For this reason, the symmetric cryptosystem may also be referred to as a secret key cryptosystem. A data encryption standard (DES), which is a block cryptographic algorithm, may be used as a symmetric cryptosystem. However, the DES may have low security due to a length of the key. Therefore, a new standard, an advanced encryption standard (AES) of block cryptographic system has been introduced. An aspect of the asymmetric cryptosystem is such that key values used in encryption and decryption may be different from each other, and an encryption key may be openly published while a decryption key may be only available to a user. The decryption key must not to be found in the published encryption key. For this reason, the asymmetric cryptosystem may be called a public key cryptosystem. The public keys may include Rivest-Shamir-Adleman (RSA) codes based on resolution of composite numbers into prime factors; ElGamal codes based on problems of discrete algebra for definite objects; knapsack codes based on knapsack problems; and elliptical-curving codes based on discrete algebra problems of elliptical curves. The public key encryption algorithm should be capable of protecting a secret key from exposure during an operation, as well as assuring reliable storage of the secret key used for decryption. Example embodiments of the present invention may provide a method of safely protecting a secret key during an operation.

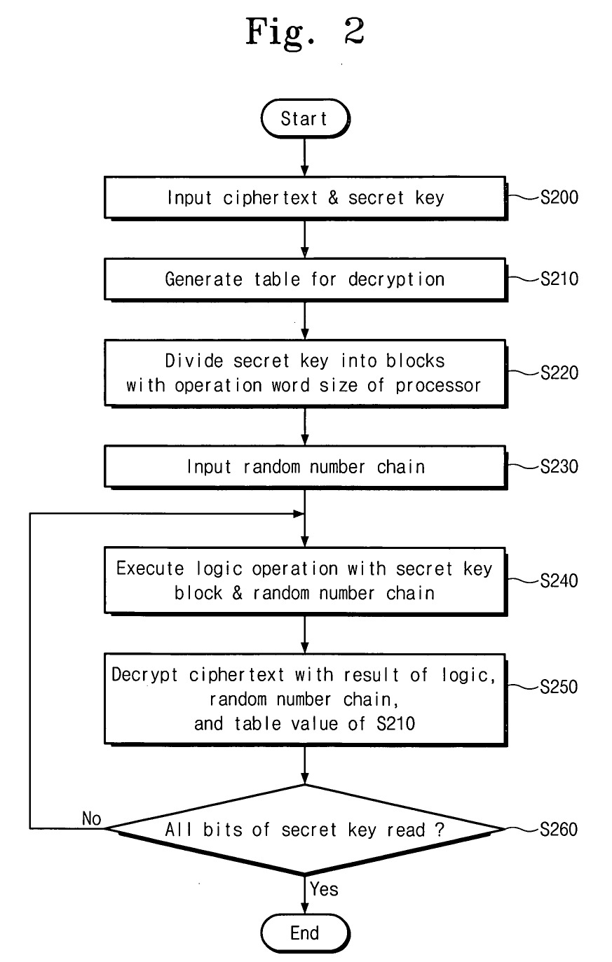

FIG. 2 is a flow chart illustrating procedure in accordance with an example embodiment of the present invention.

A processor 10 may receive a ciphertext and a secret key (S200), and create a reference table, which may be used in decrypting the ciphertext (S210). The reference table may be adapted to prevent the secret key from being directly used during a decryption operation of the ciphertext. A length of the secret key may be longer than a size of an operation word capable of being processed by the processor 10; therefore, the processor 10 may divide the secret key into a word size block it can process (S220). The processor 10 may use random number chains to protect the secret key from being disclosed during an operation. The processor 10 may receive the random number chains from a pseudo ransom number generator 20 (S230). A length of the random number may be the same as that of the divided secret key block, (the operation word size of the processor 10). The processor 10 may generate random values by executing an exclusive binary summing, for example an XOR operation, with the received random number chain and the divided secret key block (S240). The result value of S240 should not be relevant to the secret key. To significantly reduce the relevance between the secret key and the resultant value of the XOR operation, the number of the random number chains employed in the XOR operation with the secret key may be increased. As a result, a system may become reinforced against a power analysis. Since the values of the random number chains generated by the pseudo random number generator 20 may be variable to the same value of the secret key, the resultant value of the XOR operation may be different each time. Thus, as the values employed in the operation by the processor 10 may be variable even for the same value of the secret key, it may eliminate a risk of disclosing a secret key to an external attack.

The processor 10 may process an operation to decrypt the ciphertext with reference to the table preliminarily generated by means of the secret key and random number chains (S250), without using the original secret key. During this procedure, since actual bit values of the secret key may not be used in the operation, there may be little risk of disclosing the secret key to an external attack. The operation of decrypting the ciphertext may employ the resultant value obtained from the secret key and random number chains, and each bit value of the random number chain and each bit value determined by a shift bit operator. This procedure may be repeated until all the bit values of the secret key are processed in the operation of decrypting the ciphertext (S260).

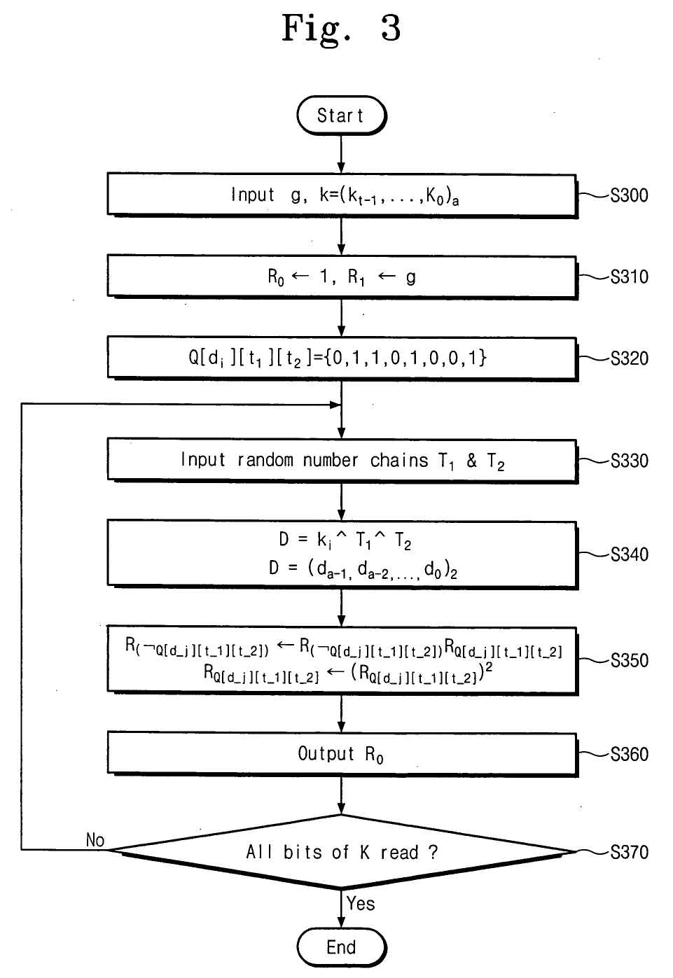

FIG. 3 is a flow chart illustrating an arithmetic procedure using a ciphertext and a secret key in accordance with an example embodiment of the invention present. A general public key cryptographic algorithm may employ a modular exponentiation scheme that is an arithmetic process of successive multiplication. FIG. 3 illustrates a procedure of obtaining a decrypted value y=g^{k} from a ciphertext g and a secret key k by a modular exponentiation operation.

A processor 10 may receive a ciphertext g and a secret key k (S300). The secret key k may be transformed to a value of unit block by segmenting it into an operation word size for the processor 10. Values R₀ and R₁ may be used in the modular exponentiation operation, R₀ and R₁ may be initialized in values of “1” and the ciphertext g, respectively (S310). Next, a table Q may be created for the ciphertext decryption operation (S320). The table Q may be configured to prevent the secret key from being directly used during the ciphertext decryption operation. The processor 10 may receive random number chains T₁ and T₂ (S330), which may be used to protect the secret key k during an operation. A length of the random number chain may be the same as that of the divided secret key block. The processor 10 may generate a random number D by executing an XOR operation with a block value Kᵢ of the secret key and the input random number chains T₁ and T₂ (S340). The random number D obtained from the XOR operation may be lengthened to the same size as that of the operation word size, the length of the secret key block value Kᵢ, or the input random number chain T₁, T₂. The processor 10 may process the ciphertext decrypting operation using the values R₀ and R₁ with reference to the table Q preliminarily generated by means of the random number D obtained from the secret key and random number chains (S350), during the modular exponentiation operation for decrypting the secret key. As the values in the table Q are “0” or “1”, the value of Q[d_i][t_{—}1][t_{—}2] or the inversed value [symbol] Q[d_i][t_{—}1][t_{—}2] may be “0” or “1”. Therefore, the value of R_{Q[d}_{_{—}}_{i][t}_{_{—}}_{1][t}_{_{—}}_{2]} or R [symbol] _{Q[d}_{_{—}}_{i][t}_{_{—}}_{1][t}_{_{—}}_{2]} may be R₀ or R₁. By outputting the value R₀ as a result of the modular exponentiation operation for decrypting the ciphertext using R₀ and R₁, a resultant value of decrypting the ciphertext may be obtained (S360). These processes may be repeated (e.g., loop back to S330) until all values of the secret key are processed in the ciphertext decryption operation (S370). As original bit values are not used in the ciphertext decryption operation, it is possible to prevent the secret key from being disclosed by an external attack, for example, a DPA.

According to the description above, example embodiments of the present invention may be effective in protecting a secret key from exposure by an external attack, for example, a power analysis attack including a DPA or a SPA. In example embodiments of the present invention, a processor of a smart card may use a table operation and values combined with a secret key and random number chains supplied from a pseudo random number generator during an operation with the secret key. Thus, the security of a smart card system may be enhanced.

Although the present invention has been described in connection with example embodiments thereof, it will be apparent to those skilled in the art that various substitution, modifications and changes may be made thereto without departing from the scope of the present invention.

What is claimed is:

1. A cryptographic method, comprising:
receiving a ciphertext and a secret key;
generating a table to be used for decryption based on the ciphertext and the secret key;
receiving at least one random number chain;
executing a logic operation with the secret key and the least one random number chain; and
decrypting the ciphertext using a resultant value of the logic operation, the random number chain, and the table.

2. The method as set forth in claim 1, wherein the secret key is divided into a plurality of blocks prior to executing the logic operation.

3. The method as set forth in claim 2, wherein a length of the at least one random number chain is equal to a length of the plurality of divided blocks.

4. The method as set forth in claim 2, wherein the ciphertext is decrypted by using an operation value of one of the plurality of divided blocks, the random number chain, and the table.

5. The method as set forth in claim 2, wherein decrypting the ciphertext includes:
detecting each bit of the resultant value of the plurality of divided blocks in sequence; and
processing each of the detected bits, the table, and the at least one random number chain.

6. The method as set forth in claim 1, wherein the resultant value of the logic operation has a low relevance to the secret key.

7. The method as set forth in claim 1, wherein the logic operation is executed to thereby lower a relevance between the resultant value of the logic operation and the secret key when two or more random number chains are used.

8. The method as set forth in claim 1, wherein the logic operation is an XOR operation.

9. A cryptographic method, comprising:
receiving a ciphertext and a secret key;
generating a table to be used for decryption based on the ciphertext and the secret key;
dividing the secret key into a plurality of blocks;
receiving at least one random number chain;
executing an XOR operation with one of the plurality of blocks and the least one random number chain; and
decrypting the ciphertext.

10. The method as set forth in claim 9, wherein decrypting the ciphertext includes:
detecting each bit of the resultant value of the plurality of blocks in sequence; and
processing each of the detected bits, the table, and the at least one random number chain.

11. A smart card, comprising:
a pseudo random number generator adapted to generate a random number chain with a definite length; and
a processor adapted to receive a ciphertext and a secret key and generate a table, the processor further adapted to receive the random number chain, execute a logic operation on the random number chain and the secret key, and execute a cipher decryption operation using a resultant value obtained from the logic operation, the table, and the random number chain.

12. The smart card as set forth in claim 11, wherein the processor is a microprocessor or a central processing unit.

13. The method as set forth in claim 11, wherein the processor is adapted to divide the secret key into a plurality of blocks prior to executing the logic operation.

14. The smart card as set forth in claim 13, wherein a length of the random number chain provided by the pseudo random number generator is equaled to a length of the plurality of divided blocks.

15. The smart card as set forth in claim 13, wherein the processor is adapted to execute the cipher decryption operation using a resultant value of one of the plurality of divided blocks, the random number chain, and the table.

16. The smart card as set forth in claim 13, wherein the processor is adapted to execute the cipher decryption operation by sequentially detecting each bit of the resultant value of the plurality of divided blocks with the secret key and the random number chain.

17. The smart card as set forth in claim 11, wherein the processor is adapted to execute the logic operation to thereby lower relevance between the resultant value of the logic operation and the secret key when two or more random number chains are used.

18. The smart card as set forth in claim 11, wherein the table generated by the processor is configured to prevent bits of the secret key from being leaked during the execution of the cipher decryption operation.

19. The smart card as set forth in claim 11, wherein the logic operation is an XOR operation.

20. The smart card as set forth in claim 11, further including:
an input/output (I/O) interface to adapted transfer data between the smart card and external apparatuses;
a random only memory (ROM) adapted to contain an operating system and instructions for the smart card;
a random access memory (RAM) adapted to store temporary data and calculated results; and
a bus operatively adapted to transfer data within the smart card between the I/O interface, RAM, ROM, pseudo random number generator, and processor.
